(19) United States
(12) Patent Application Publication
(10) Pub. No.: US 2023/0288182 A1
(43) Pub. Date: Sep. 14, 2023

(54) OPTICAL COMPLEX AMPLITUDE MEASUREMENT DEVICE AND OPTICAL COMPLEX AMPLITUDE MEASUREMENT METHOD

(71) Applicant: Nippon Telegraph and Telephone Corporation, Tokyo (JP)

(72) Inventors: Hiroki SAKUMA, Musashino-shi, Tokyo (JP); Kaoru ARAI, Musashino-shi, Tokyo (JP); Ryuta SUGIYAMA, Musashino-shi, Tokyo (JP); Tomoya AKATSUKA, Musashino-shi, Tokyo (JP); Katsuya OGURI, Musashino-shi, Tokyo (JP)

(21) Appl. No.: 18/019,530

(22) PCT Filed: Aug. 4, 2020
(86) PCT No.: PCT/JP2020/029767

§ 371 Date: Feb. 3, 2023

(51) Int. Cl. G01B 9/02003; G01B 9/02015; G01B 9/02001; G01B 9/02

(52) U.S. Cl. CPC G01B 9/02003; G01B 9/0203; G01B 9/02011; G01B 9/02083; G01B 2290/70

(57) ABSTRACT

An optical complex amplitude measurement apparatus causes a polarization controller to perform control of making a polarized beam of a signal beam having a frequency that is output from a first laser and then passes through a measurement target match with a polarized beam of a reference beam from a second laser. A spatial filter extracts, from the matched signal beam, a plane wave component in which a wave front is distorted due to the passage, and outputs a signal beam having the frequency. The second laser performs a phase synchronization control of a frequency of the reference beam such that a frequency difference due to multiplexing of the signal beam and the reference beam by a homodyne interferometer becomes 0. The controlled reference beam and the signal beam from the polarization controller are multiplexed by a beam splitter.

### TECHNICAL FIELD

The present invention relates to an optical complex amplitude measurement apparatus and an optical complex amplitude measurement method using a homodyne interferometer, which are applied to various fields such as biometric measurement and surface measurement.

### BACKGROUND ART

In the various fields described above, a technique for measuring an optical complex amplitude including information related to both an intensity and a phase of an optical wave is used. Digital holography is a representative method in optical complex amplitude measurement techniques.

In digital holography, a signal beam including information of a measurement object is obtained, and the signal beam and a coherent reference beam are multiplexed. Then, an intensity distribution (interference fringe) caused by interference due to the multiplexing is acquired by a camera. By performing specific image processing on the acquired interference fringe by a calculator, an intensity distribution and a phase distribution (wave front) can be measured.

In measurement by digital holography, a measurement target may be at a long distance, such as an optical fiber between remote buildings or the atmosphere between buildings. In a case of measuring a measurement target, there is a method in which a signal beam from a light source is split into beams for two optical paths in advance and one of the beams is used as a reference beam. In this method, it is necessary to separately prepare an optical fiber for transmitting the reference beam and transmit the reference beam. As a result, a transmission cost increases. In addition, the optical fiber cannot be provided in circumstances where there are economical difficulties or physical difficulties.

For this reason, digital holography without using a reference beam has been proposed. In this digital holography, a signal beam from a light source is optically split, and then passes through a spatial filter to be described later. Thereby, a reference beam including plane wave components is generated. FIG. 5 illustrates a configuration example of an optical complex amplitude measurement apparatus for digital holography.

An optical complex amplitude measurement apparatus 10 illustrated in FIG. 5 includes a laser 11 as a light source, beam splitters 12 and 16, a spatial filter 13, mirrors 14 and 15, a camera 17, and a personal computer 18. Here, a measurement target 21 which is the atmosphere is interposed, for example, between the laser 11 and the beam splitter 12.

The laser 11 outputs (emits) a laser beam. The output laser beam passes through the measurement target 21, and thus a signal beam L11 is obtained. The signal beam L11 is input (incident) to the beam splitter 12. The beam splitter 12 splits the signal beam L11 by passing and reflecting the signal beam L11, outputs one split signal beam L11 to the spatial filter 13, and outputs the other split signal beam L11 to the mirror 15. The mirror 15 reflects the signal beam L11, and outputs the signal beam L11 to the beam splitter 16.

The spatial filter 13 extracts a plane wave component which is included in the signal beam L11 and in which a wave front is distorted due to the passage through the measurement target 21, and outputs a reference beam L12 including the extracted plane wave component. The output reference beam L12 is reflected by the mirror 14, and is output to the beam splitter 16.

The beam splitter 16 multiplexes the signal beam L11 and the reference beam L12, and outputs, to the camera 17, an interference fringe I1 that corresponds to an intensity distribution due to the multiplexing. The camera 17 acquires the interference fringe I1 and outputs interference fringe information I1a to the personal computer 18 via a conductive wire. The personal computer 18 calculates an intensity distribution and a phase distribution of the signal beam by performing specific image processing on the interference fringe information I1a (performing measurement processing).

This type of technique is described in Non Patent Literature 1.

### CITATION LIST

### Non Patent Literature

Non Patent Literature 1: T. Maeda, A. Okamoto, A. Tomita, Y. Hirasaki, Y. Wakayama, and M. Bunsen, “Holographic-Diversity Interferometry for Reference-Free Phase Detection,” in 2013 Conference on Lasers and Electro-Optics Pacific Rim, (Optical Society of America, 2013), paper WF4_4 (2013)

### SUMMARY OF INVENTION

### Technical Problem

However, in the optical complex amplitude measurement apparatus 10 described above, an optical power of the reference beam L12 obtained by the spatial filter 13 depends on an amount of the plane wave components included in the signal beam L11 passing through the measurement target 21. The spatial filter 13 extracts the plane wave component included in the signal beam L11. However, in a case where a distortion amount of the wave front in the signal beam L11 is changed, the amount of the plane wave components is changed, and as a result, the optical power of the reference beam L12 varies.

A relationship between the amount of the plane wave components of the signal beam L11 and the optical power of the reference beam L12 is indicated by a line E1 in FIG. 6. As indicated by the line E1, in a case where the optical power of the reference beam L12 varies and decreases, the amount of the plane wave components decreases in proportion to the optical power. For this reason, a contrast of the interference fringe I1 may be reduced or the interference fringe may be eliminated. As a result, there is a problem that measurement accuracy is deteriorated or measurement cannot be performed.

The present invention has been made in view of such circumstances, and an object of the present invention is to prevent a decrease in contrast of the interference fringe related to the signal beam passing through the measurement target and elimination of the interference fringe, and to measure an intensity distribution and a phase distribution of the interference fringe with high accuracy by the prevention.

### Solution to Problem

In order to solve the above problems, there is provided an optical complex amplitude measurement apparatus including: a first light source that outputs a signal beam having a frequency f1; a second light source that outputs a signal beam having a frequency f2 as a reference beam; a polarization controller that performs a control of making a polarized beam of the signal beam which is output from the first light source and then passes through a measurement target match with a polarized beam of the reference beam output from the second light source; a spatial filter that extracts, from the matched signal beam related to the first light source, a plane wave component in which a wave front is distorted due to passage through the measurement target and outputs the signal beam which has the frequency f1 and includes the extracted plane wave component; a homodyne interferometer that multiplexes both the signal beam having the frequency f1 from the spatial filter and the reference beam having the frequency f2 from the second light source and inputs a beat signal due to a frequency difference (f1−f2) between the signal beam and the reference beam to a control end of the second light source; and a multiplexer that multiplexes the reference beam from the second light source and the signal beam from the polarization controller, wherein the second light source performs a phase synchronization control of the frequency of the reference beam to be output from the second light source such that the frequency difference (f1−f2) of the beat signal which is input to the control end becomes 0.

### Advantageous Effects of Invention

According to the present invention, it is possible to prevent a decrease in contrast of the interference fringe related to the signal beam passing through the measurement target and elimination of the interference fringe, and to measure an intensity distribution and a phase distribution of the interference fringe with high accuracy by the prevention.

### BRIEF DESCRIPTION OF DRAWINGS

FIG. 1 is a block diagram illustrating a configuration of an optical complex amplitude measurement apparatus using a homodyne interferometer according to a first embodiment of the present invention.

FIG. 2 is a first flowchart for explaining an operation for optical complex amplitude measurement by the optical complex amplitude measurement apparatus according to the first embodiment.

FIG. 3 is a second flowchart for explaining an operation for optical complex amplitude measurement by the optical complex amplitude measurement apparatus according to the first embodiment.

FIG. 4 is a block diagram illustrating a configuration of an optical complex amplitude measurement apparatus using a homodyne interferometer according to a second embodiment of the present invention.

FIG. 5 is a block diagram illustrating a configuration of an optical complex amplitude measurement apparatus in the related art.

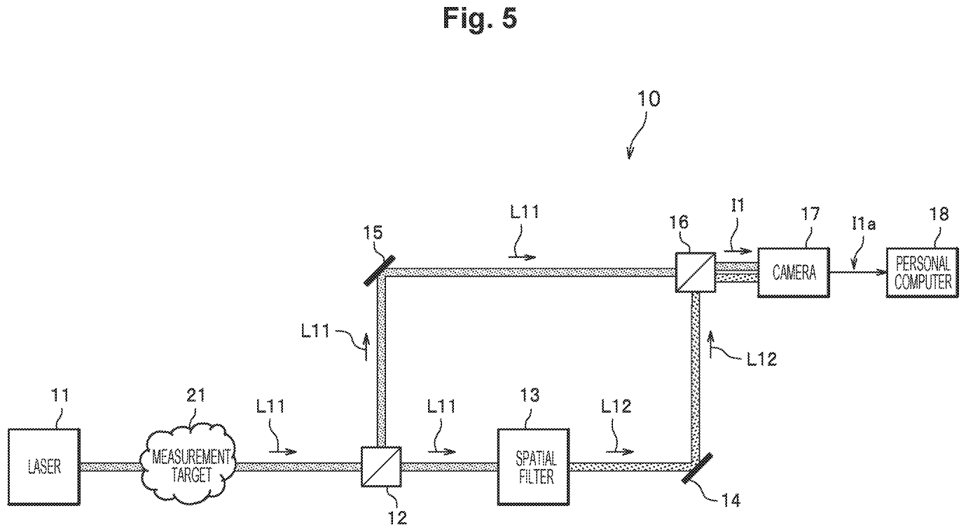

FIG. 6 is a diagram of a relationship between optical power of a reference beam and an amount of plane wave components in a signal beam.

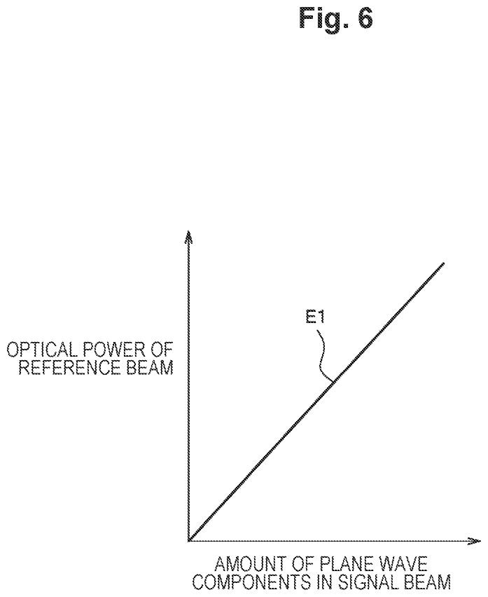

### DESCRIPTION OF EMBODIMENTS

Hereinafter, embodiments of the present invention will be described with reference to the drawings. Here, in all the drawings in the present description, components having corresponding functions are denoted by the same reference numerals, and description thereof will be appropriately omitted.

<Configuration of First Embodiment>

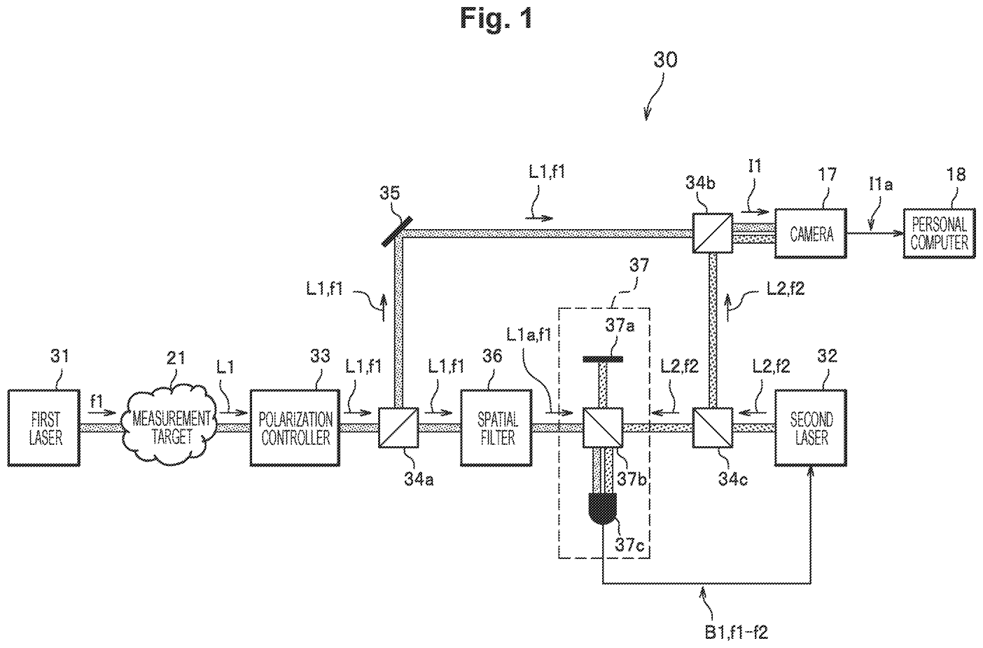

FIG. 1 is a block diagram illustrating a configuration of an optical complex amplitude measurement apparatus using a homodyne interferometer according to a first embodiment of the present invention.

An optical complex amplitude measurement apparatus 30 illustrated in FIG. 1 includes a first laser 31 and a second laser 32 as light sources, a polarization controller 33, beam splitters 34a, 34b, and 34c, a mirror 35, a spatial filter 36, a homodyne interferometer 37, a camera 17, and a personal computer 18. The homodyne interferometer 37 includes a mirror 37a, a beam splitter 37b, and a photo diode 37c. Here, a measurement target 21 is interposed between the first laser 31 and the polarization controller 33. In the present example, the measurement target 21 is the atmosphere, and may be an optical fiber or the like.

The first laser 31 constitutes a first light source according to the claims, and the second laser 32 constitutes a second light source according to the claims. The beam splitter 34b constitutes a multiplexer according to the claims. The personal computer 18 constitutes a calculator according to the claims.

As a feature of the first embodiment, the optical complex amplitude measurement apparatus 30 uses two light sources as the first and second lasers 31 and 32 that output (emit) laser beams having same frequencies f1 and f2. In a case where the frequencies f1 and f2 of the two laser beams do not match with each other, an interference fringe I1 which is input to the camera 17 becomes faded or is eliminated. As a result, the interference fringe I1 cannot be appropriately detected. For this reason, the frequency f2 of the laser beam from the second laser 32 is caused to match with the frequency f1 of the laser beam which is output from the first laser 31 and then passes through the measurement target 21, by using the homodyne interferometer 37.

The first laser 31 outputs a laser beam having a frequency f1. The output laser beam passes through the measurement target 21, and thus a signal beam L1 having the frequency f1 is obtained. The signal beam L1 is input (incident) to the polarization controller 33.

The polarization controller 33 performs control of making a polarized beam of the signal beam L1 match with a polarized beam of a reference beam L2 as a laser beam from the second laser 32. The matched signal beam L1 is input to the beam splitter 34a. Note that the reference beam L2 from the second laser 32 is input to the polarization controller 33 via a path of the beam splitters 34c and 37b, the spatial filter 36, and the beam splitter 34a, the reference beam L2 being input to the polarization controller 33.

The beam splitter 34a splits the signal beam L1 having the frequency f1 from the polarization controller 33 by passing and reflecting the signal beam L1, outputs one split signal beam L1 to the spatial filter 36, and outputs the other split signal beam L1 to the mirror 35. The mirror 35 reflects the signal beam L1, and outputs the signal beam L1 to the beam splitter 34b.

The spatial filter 36 extracts a plane wave component which is included in the signal beam L1 and in which a wave front is distorted due to the passage through the measurement target 21, and outputs the signal beam L1a which has the frequency f1 and includes the extracted plane wave component to the beam splitter 37b of the homodyne interferometer 37.

On the other hand, the second laser 32 outputs, as the reference beam L2, a laser beam having the same frequency f2 as the frequency f1. The output reference beam L2 is split by the beam splitter 34c. One split reference beam L2 is output to the beam splitter 34b. The other split reference beam L2 is output to the beam splitter 37b of the homodyne interferometer 37.

In the homodyne interferometer 37, the reference beam L2 is reflected by the beam splitter 37b. The reflected reference beam L2 is reflected by the mirror 37a, and is input to the beam splitter 37b again. In the beam splitter 37b, the reference beam L2 and the signal beam L1a from the spatial filter 36 are multiplexed. The photo diode 37c converts a beat beam due to a difference (also referred to as a frequency difference) between the frequencies f1 and f2 of the multiplexed signal beam L1a and the multiplexed reference beam L2 into a beat signal B1 serving as an electrical signal. The converted beat signal B1 is input to the control end of the second laser 32 via the conductive wire.

The second laser 32 performs a phase synchronization control of the frequency f2 of the reference beam L2 to be output from the second laser 32 such that a frequency difference (f1−f2) of the beat signal B1 becomes 0. The controlled reference beam L2 passes through the beam splitter 34c and then is fed back to the homodyne interferometer 37, while the controlled reference beam L2 is reflected by the beam splitter 34c and then is input to the other beam splitter 34b.

The beam splitter 34b multiplexes the signal beam L1 and the reference beam L2, and outputs, to the camera 17, an interference fringe I1 that corresponds to an intensity distribution by the multiplexing. The camera 17 acquires the interference fringe I1 and outputs interference fringe information I1a to the personal computer 18 via a conductive wire. The personal computer 18 calculates a light intensity and a phase of the signal beam L1 by performing specific image processing on interference fringe information I1a (performing measurement processing).

<Operation of First Embodiment>

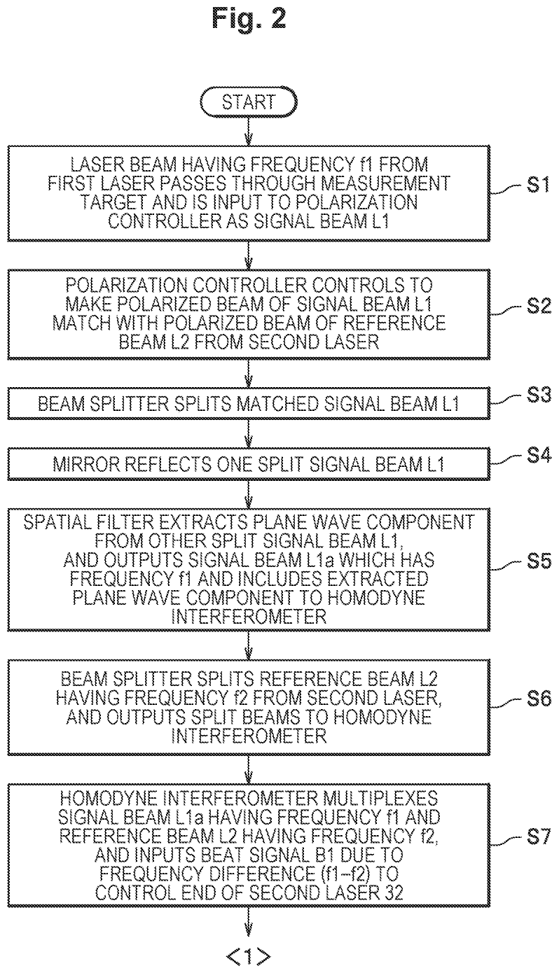

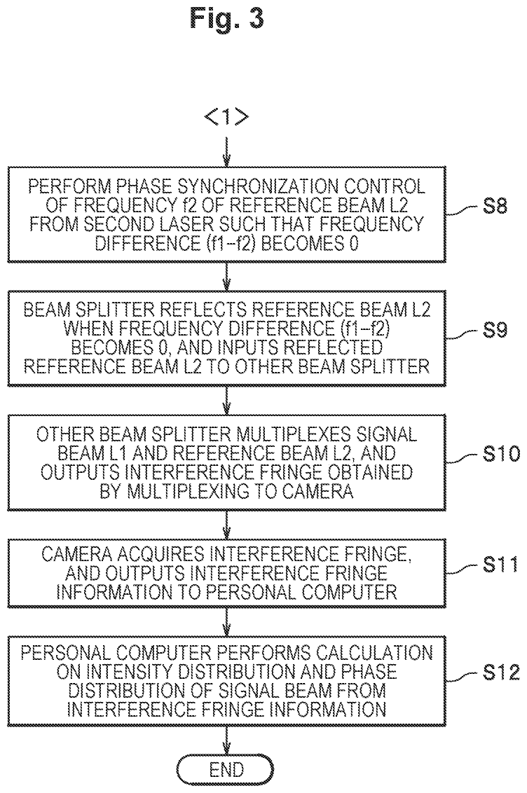

Next, an optical complex amplitude measurement operation by the optical complex amplitude measurement apparatus 30 according to the first embodiment will be described with reference to flowcharts of FIG. 2 and FIG. 3.

In step S1 illustrated in FIG. 2, the laser beam having the frequency f1 that is output from the first laser 31 passes through the measurement target 21, and the signal beam L1 having the frequency f1 that is obtained by the passage is input to the polarization controller 33.

In step S2, the polarization controller 33 performs a control such that the polarized beam of the signal beam L1 which is input matches with the polarized beam of the reference beam L2 which is output from the second laser 32, and the matched signal beam L1 is input to the beam splitter 34a.

In step S3, the beam splitter 34a splits the signal beam L1 having the frequency f1 from the polarization controller 33. One split signal beam L1 is output to the spatial filter 36, and the other split signal beam L1 is output to the mirror 35.

In step S4, the signal beam L1 is reflected by the mirror 35, and is output to the beam splitter 34b.

In step S5, the spatial filter 36 extracts a plane wave component which is included in the signal beam L1 and in which a wave front is distorted due to the passage of the measurement target 21. Further, the signal beam L1a which has the frequency f1 and includes the extracted plane wave component is output to the beam splitter 37b of the homodyne interferometer 37 from the spatial filter 36.

In step S6, the reference beam L2 having the frequency f2 is output from the second laser 32, and the reference beam L2 is split by the beam splitter 34c. One split reference beam L2 is output to the beam splitter 34b, and the other split reference beam L2 is output to the beam splitter 37b of the homodyne interferometer 37.

In step S7, the reference beam L2 is reflected by the beam splitter 37b of the homodyne interferometer 37. The reflected reference beam L2 is reflected by the mirror 37a, and is input to the beam splitter 37b again. In the beam splitter 37b, the reference beam L2 and the signal beam L1a from the spatial filter 36 are multiplexed. The beat signal B1 due to a frequency difference (f1−f2) between the multiplexed signal beam L1a and the multiplexed reference beam L2 is input from the photo diode 37c to the control end of the second laser 32 via the conductive wire.

Referring to FIG. 3, in step S8, the second laser 32 performs a phase synchronization control of the frequency f2 of the reference beam L2 to be output from the second laser 32 such that the frequency difference (f1−f2) becomes 0. Next, the process proceeds to step S9.

In step S9, the reference beam L2 controlled such that the frequency difference (f1−f2) becomes 0 is reflected by the beam splitter 34c, and then is input to the other beam splitter 34b.

In step S10, the signal beam L1 and the reference beam L2 are multiplexed by the beam splitter 34b, and the interference fringe I1 obtained by the multiplexing is output to the camera 17.

In step S11, the camera 17 acquires interference fringe information I1a by capturing the interference fringe I1, and outputs the acquired interference fringe information I1a to the personal computer 18.

In step S12, the personal computer 18 performs specific image processing of calculating the light intensity and the phase of the signal beam L1 from the interference fringe information I1a (performs measurement processing).

<Effects of First Embodiment>

Effects of the optical complex amplitude measurement apparatus 30 according to the first embodiment will be described.

(1a) The optical complex amplitude measurement apparatus 30 includes a first laser 31, a second laser 32, a polarization controller 33, a spatial filter 36, a homodyne interferometer 37, and a beam splitter 34b.

The first laser 31 outputs a signal beam L1 having a frequency f1. The second laser 32 outputs a signal beam L1 having a frequency f2 as a reference beam L2, and performs a phase synchronization control of making the frequency f2 match with the frequency f1. The polarization controller 33 performs a control of making a polarized beam of the signal beam L1, which is output from the first laser 31 and passes through a measurement target 21, match with a polarized beam of the reference beam L2 output from the second laser 32.

The spatial filter 36 extracts, from the matched signal beam L1 related to the first laser 31, a plane wave component in which a wave front is distorted due to the passage of the measurement target 21, and outputs the signal beam L1a which has the frequency f1 and includes the extracted plane wave component. The homodyne interferometer 37 multiplexes both the signal beam L1a having the frequency f1 from the spatial filter 36 and the reference beam L2 having the frequency f2 from the second laser 32, and inputs the beat signal B1 due to the frequency difference (f1−f2) between the signal beam L1a and the reference beam L2 to the control end of the second laser 32. The beam splitter 34b multiplexes the reference beam L2 from the second laser 32 and the signal beam L1 from the polarization controller 33. Further, the second laser 32 is configured to perform a phase synchronization control of the frequency of the reference beam L2 to be output from the second laser 32 such that the frequency difference (f1−f2) of the beat signal B1 to be input to the control end becomes 0.

According to this configuration, the polarized beam of the signal beam L1 which has the frequency f1 and is output from the first laser 31 is matched with the polarized beam of the reference beam L2 which has the frequency f2 and is output from the second laser 32. Further, the second laser 32 performs a phase synchronization control of the frequency of the reference beam L2 to be output from the second laser 32 such that the frequency difference (f1−f2) between the signal beam L1 having the frequency f1 and the signal beam L1 having the frequency f2 becomes 0. The signal beam L1 and the reference beam L2 when the frequency difference (f1−f2) becomes 0 by the control are multiplexed by the beam splitter 34b.

The reference beam L2 at this time is directly output from the second laser 32, and thus optical power can be stabilized. Further, the frequency difference (f1−f2) between the signal beam L1 which has the frequency f1 and is related to the first laser 31 and the reference beam L2 having the frequency f2 becomes 0 by the phase synchronization control. Therefore, an interference fringe obtained by multiplexing the signal beam L1 and the reference beam L2 by the beam splitter 34b has clear contrast. In other words, it is possible to prevent the contrast of the interference fringe from being decreased, and it is possible to prevent the interference fringe from being eliminated, the interference fringe being related to the signal beam L1 passing through the measurement target 21.

(2a) The camera 17 that captures an image of the interference fringe and obtains interference fringe information from the captured interference fringe is provided, the interference fringe being obtained by multiplexing the reference beam L2 from the second laser 32 and the signal beam L1 from the polarization controller 33 by the beam splitter 34b. In addition, there is further provided a personal computer 18 that measures an intensity distribution and a phase distribution of the signal beam L1 from the interference fringe information obtained by the camera 17.

According to this configuration, the reference beam L2 which is multiplexed with the signal beam L1 by the beam splitter 34b is directly output from the second laser 32. Thus, optical power can be stabilized. Therefore, the personal computer 18 calculates the interference fringe information obtained by capturing the interference fringe by the camera 17, the interference fringe being obtained by multiplexing the signal beam L1 and the reference beam L2 by the beam splitter 34b. Thereby, it is possible to measure the intensity distribution and the phase distribution of the signal beam L1 with high accuracy.

<Configuration of Second Embodiment>

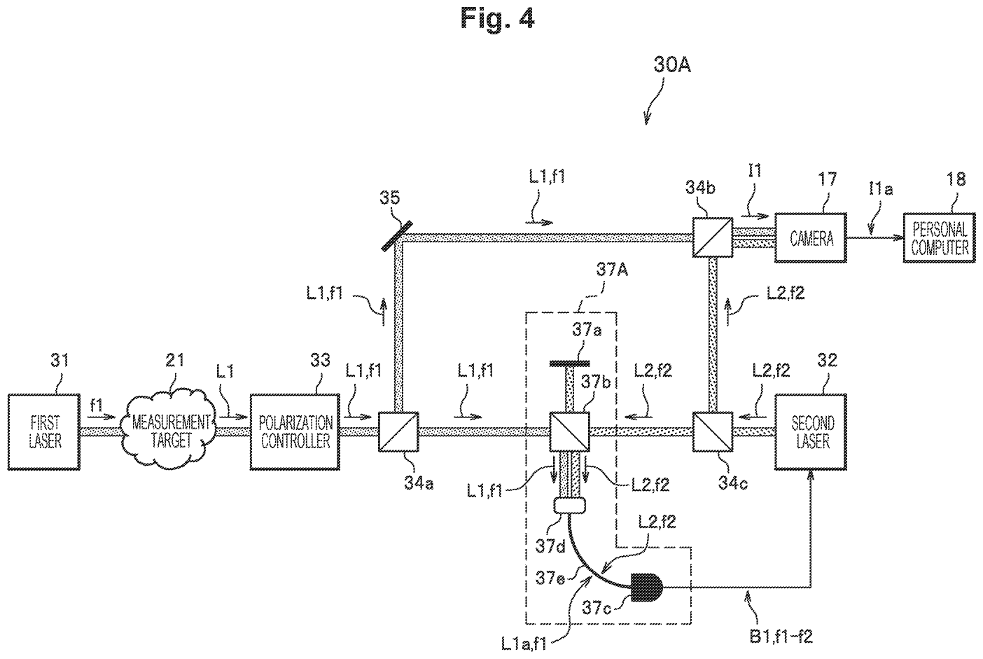

FIG. 4 is a block diagram illustrating a configuration of an optical complex amplitude measurement apparatus using a homodyne interferometer according to a second embodiment of the present invention.

The optical complex amplitude measurement apparatus 30A according to the second embodiment illustrated in FIG. 4 is different from the optical complex amplitude measurement apparatus 30 (FIG. 1) according to the first embodiment in that a homodyne interferometer 37A having a configuration different from the configuration of the homodyne interferometer according to the first embodiment is provided and a spatial filter 36 (FIG. 1) is not provided.

The homodyne interferometer 37A includes a mirror 37a, a beam splitter 37b, an optical fiber coupler 37d, a single-mode optical fiber 37e, and a photo diode 37c.

One end of the single-mode optical fiber 37e is connected to the beam splitter 37b via the optical fiber coupler 37d, and the other end of the single-mode optical fiber 37e is connected to the photo diode 37c. The single-mode optical fiber 37e performs plane wave component extraction processing which is the same processing as the processing of the spatial filter 36 (FIG. 1). That is, the single-mode optical fiber 37e extracts a plane wave component which is included in the signal beam L1 and in which a wave front is distorted due to the passage through the measurement target 21, multiplexes the signal beam L1a which has the frequency f1 and includes the extracted plane wave component and the reference beam L2 having the frequency f2, and outputs a beam obtained by the multiplexing to the photo diode 37c.

The photo diode 37c converts a beat beam due to a frequency difference (f1−f2) between the multiplexed signal beam L1a and the multiplexed reference beam L2 into a beat signal B1 serving as an electrical signal, and inputs the beat signal B1 to the control end of the second laser 32 via the conductive wire.

The second laser 32 performs a phase synchronization control of the frequency f2 of the reference beam L2 to be output from the second laser 32 such that a frequency difference (f1−f2) of the beat signal B1 becomes 0. The controlled reference beam L2 passes through the beam splitter 34c and then is fed back to the homodyne interferometer 37A, while the controlled reference beam L2 is reflected by the beam splitter 34c and then is input to the other beam splitter 34b.

The signal beam L1 and the reference beam L2 are multiplexed by the beam splitter 34b, and the interference fringe I1 obtained by the multiplexing is output to the camera 17. The interference fringe information I1a is output from the camera 17 to the personal computer 18 via the conductive wire. The personal computer 18 executes calculation processing of an intensity distribution and a phase distribution of the signal beam L1 from the interference fringe information I1a.

<Effects of Second Embodiment>

Effects of the optical complex amplitude measurement apparatus 30A according to the second embodiment will be described.

(1b) The optical complex amplitude measurement apparatus 30A includes a first laser 31, a second laser 32, a polarization controller 33, a homodyne interferometer 37A, and a beam splitter 34b.

The first laser 31 outputs a signal beam L1 having a frequency f1. The second laser 32 outputs a signal beam L1 having a frequency f2 as a reference beam L2, and performs a phase synchronization control of the frequency f2 with respect to the frequency f1. The polarization controller 33 performs a control of making a polarized beam of the signal beam L1, which is output from the first laser 31 and passes through a measurement target 21, match with a polarized beam of the reference beam L2 output from the second laser 32.

The homodyne interferometer 37A includes the single-mode optical fiber 37e that extracts, from the matched signal beam L1 related to the first laser 31, a plane wave component in which a wave front is distorted due to the passage through the measurement target 21, multiplexes both the signal beam L1a which has the frequency f1 and includes the extracted plane wave component and the reference beam L2 having the frequency f2 from the second laser 32, and transmits a beam obtained by the multiplexing. Further, the homodyne interferometer 37A inputs, to the control end of the second laser 32, the beat signal B1 due to the frequency difference (f1−f2) between the signal beam L1a and the reference beam L2 from the single-mode optical fiber 37e. The beam splitter 34b multiplexes the reference beam L2 from the second laser 32 and the signal beam L1 from the polarization controller 33. Further, the second laser 32 is configured to perform a phase synchronization control of the frequency of the reference beam L2 to be output from the second laser 32 such that the frequency difference (f1−f2) of the beat signal B1 to be input to the control end becomes 0.

According to this configuration, the same functions and effects as those of the optical complex amplitude measurement apparatus 30 (FIG. 1) according to the first embodiment can be obtained. Further, as compared with the optical complex amplitude measurement apparatus 30, the spatial filter 36 is not necessary in the optical complex amplitude measurement apparatus 30A according to the second embodiment. Therefore, it is possible to reduce a size of the apparatus by the spatial filter 36.

(2b) Similarly to the first embodiment, the optical complex amplitude measurement apparatus 30A according to the second embodiment further includes a camera 17 and a personal computer 18. According to this configuration, the same effects as those of the first embodiment can be obtained.

In actual measurement, it is necessary to appropriately change the first and second embodiments according to an algorithm used when calculating the intensity distribution and the phase distribution of the signal beam from the interference fringe information I1a. For example, in the optical complex amplitude measurement apparatuses 30 and 30A, there may be a case where a phase modulation element is inserted between the beam splitter 34c and the beam splitter 34b and a case where the beam splitter 34b is tilted and the reference beam L2 with an angle is multiplexed with the signal beam L1.

<Effects>

(1) There is provided an optical complex amplitude measurement apparatus including: a first light source that outputs a signal beam having a frequency f1; a second light source that outputs a signal beam having a frequency f2 as a reference beam; a polarization controller that performs a control of making a polarized beam of the signal beam which is output from the first light source and then passes through a measurement target match with a polarized beam of the reference beam output from the second light source; a spatial filter that extracts, from the matched signal beam related to the first light source, a plane wave component in which a wave front is distorted due to passage through the measurement target and outputs the signal beam which has the frequency f1 and includes the extracted plane wave component; a homodyne interferometer that multiplexes both the signal beam having the frequency f1 from the spatial filter and the reference beam having the frequency f2 from the second light source and inputs a beat signal due to a frequency difference (f1−f2) between the signal beam and the reference beam to a control end of the second light source; and a multiplexer that multiplexes the reference beam from the second light source and the signal beam from the polarization controller, in which the second light source performs a phase synchronization control of the frequency of the reference beam to be output from the second light source such that the frequency difference (f1−f2) of the beat signal which is input to the control end becomes 0.

According to this configuration, the polarized beam of the signal beam which has the frequency f1 and is output from the first light source is matched with the polarized beam of the reference beam which has the frequency f2 and is output from the second light source. Further, the second light source performs a phase synchronization control of the frequency of the reference beam to be output from the second light source such that the frequency difference (f1−f2) between the signal beam having the frequency f1 and the signal beam having the frequency f2 becomes 0. The signal beam and the reference beam when the frequency difference (f1−f2) becomes 0 by the control are multiplexed by the multiplexer.

The reference beam at this time is directly output from the second light source, and thus optical power can be stabilized. Further, the frequency difference (f1−f2) between the signal beam which has the frequency f1 and is related to the first light source and the reference beam having the frequency f2 becomes 0 by the phase synchronization control. Therefore, an interference fringe obtained by multiplexing the signal beam and the reference beam by the multiplexer has clear contrast. In other words, it is possible to prevent the contrast of the interference fringe from being decreased, and it is possible to prevent the interference fringe from being eliminated, the interference fringe being related to the signal beam passing through the measurement target.

(2) There is provided an optical complex amplitude measurement apparatus including: a first light source that outputs a signal beam having a frequency f1; a second light source that outputs a signal beam having a frequency f2 as a reference beam; a polarization controller that performs a control of making a polarized beam of the signal beam which is output from the first light source and then passes through a measurement target match with a polarized beam of the reference beam output from the second light source; a homodyne interferometer that includes a single-mode optical fiber, which extracts, from the matched signal beam related to the first light source, a plane wave component in which a wave front is distorted due to passage through the measurement target, multiplexes both the signal beam which has the frequency f1 and includes the extracted plane wave component and the reference beam having the frequency f2 from the second light source, and transmits a beam obtained by the multiplexing, and inputs a beat signal due to a frequency difference (f1−f2) between the signal beam and the reference beam to a control end of the second light source; and a multiplexer that multiplexes the reference beam from the second light source and the signal beam from the polarization controller, in which the second light source performs a phase synchronization control of the frequency of the reference beam to be output from the second light source such that the frequency difference (f1−f2) of the beat signal which is input to the control end becomes 0.

According to this configuration, the same functions and effect as those of the optical complex amplitude measurement apparatus according to Claim 1 can be obtained. On the other hand, as compared with the optical complex amplitude measurement apparatus, a spatial filter is not necessary. Thus, it is possible to reduce a size of the apparatus by that of the spatial filter.

(3) The optical complex amplitude measurement apparatus according to (1) or (2) further includes: a camera that captures an interference fringe obtained by multiplexing the reference beam after the phase synchronization control and the signal beam from the polarization controller by the multiplexer; and a calculator that performs image processing for calculating an intensity distribution and a phase distribution of the signal beam from interference fringe information obtained by the camera.

According to this configuration, the reference beam which is multiplexed with the signal beam by the multiplexer is directly output from the second light source. Thus, optical power can be stabilized. Therefore, the calculator performs image processing on the interference fringe information obtained by capturing the interference fringe by the camera, the interference fringe being obtained by multiplexing the signal beam and the reference beam by the multiplexer. Thereby, it is possible to measure the intensity distribution and the phase distribution of the signal beam with high accuracy.

In addition to the above, the specific configuration can be modified as appropriate, without departing from the scope of the present invention.

### REFERENCE SIGNS LIST

17 Camera
18 Personal computer (calculator)
30, 30A Optical complex amplitude measurement apparatus
31 First laser (first light source)
32 Second laser (second light source)
33 Polarization controller
34a, 34c, 37b Beam splitter
34b Beam splitter (multiplexer)
35, 37a Mirror
36 Spatial filter
37, 37A Homodyne interferometer
37c Photo diode
37d Optical fiber coupler
37e Single-mode optical fiber

1. An optical complex amplitude measurement apparatus comprising:
a first light source that outputs a first signal beam having a first frequency;
a second light source that outputs a second signal beam having a second frequency as a reference beam;
a polarization controller, implemented using one or more computing devices, configured to make a polarized beam of the first signal beam, output from the first light source and passed through a measurement target, match with a polarized beam of the reference beam output from the second light source;
a spatial filter configured to:
extract, from the matched signal beam related to the first light source, a plane wave component in which a wave front is distorted due to passage through the measurement target, and
output an ouptut signal beam that has the first frequency and that includes the extracted plane wave component;
a homodyne interferometer configured to:
multiplex both the output signal beam having the first frequency from the spatial filter and the reference beam having the second frequency from the second light source, and
input a beat signal due to a frequency difference between the first frequency of the output signal beam and the second frequency of the reference beam to a control end of the second light source; and
a multiplexer configured to multiplex the reference beam from the second light source and the polarized beam of the first signal beam from the polarization controller,
wherein the second light source is configured to perform a phase synchronization control of the frequency of the reference beam to be output from the second light source causing the frequency difference of the beat signal which is input to the control end becomes zero.

2. An optical complex amplitude measurement apparatus comprising:
a first light source that outputs a first signal beam having a first frequency;
a second light source that outputs a second signal beam having a second frequency as a reference beam;
a polarization controller, implemented using one or more computing devices, configured to make a polarized beam of the first signal beam, output from the first light source and passed through a measurement target, match with a polarized beam of the reference beam output from the second light source;
a homodyne interferometer that includes a single-mode optical fiber and that is configured to:
extract, from the matched signal beam related to the first light source, a plane wave component in which a wave front is distorted due to passage through the measurement target,
multiplex both (i) the signal beam having the first frequency and including the extracted plane wave component and (ii) the reference beam having the second frequency from the second light source,
transmit a beam obtained by multiplexing the signal beam and the reference beam, and
input a beat signal due to a frequency difference between the first frequency of the signal beam and the second frequency of the reference beam to a control end of the second light source; and
a multiplexer configured to multiplex the reference beam from the second light source and the polarized beam of the first signal beam from the polarization controller,
wherein the second light source is configured to perform a phase synchronization control of the frequency of the reference beam to be output from the second light source causing the frequency difference of the beat signal which is input to the control end becomes zero.

3. The optical complex amplitude measurement apparatus according to claim 1, further comprising:
a camera configured to capture an interference fringe obtained by multiplexing, by the multiplexer, the reference beam after the phase synchronization control and the polarized beam of the first signal beam from the polarization controller; and
a calculator configured to perform image processing for calculating an intensity distribution and a phase distribution of the polarized beam of the first signal beam from interference fringe information obtained by the camera.

4. An optical complex amplitude measurement method performed by an optical complex amplitude measurement apparatus that includes a first light source, a second light source, a polarization controller, a spatial filter, a homodyne interferometer, and a multiplexer, the method comprising:
a step of outputting a signal beam having a first frequency from the first light source;
a step of outputting a signal beam having a second frequency as a reference beam from the second light source;
a step of, via the polarization controller, making a polarized beam of the first signal beam, output from the first light source and passed through a measurement target, match with a polarized beam of the reference beam output from the second light source;
a step of, via the spatial filter, extracting, from the matched signal beam related to the first light source, a plane wave component in which a wave front is distorted due to passage through the measurement target and outputting an output signal beam having the first frequency and including the extracted plane wave component;
a step of, via the homodyne interferometer, multiplexing both the output signal beam having the first frequency from the spatial filter and the reference beam having the second frequency from the second light source, and inputting, to a control end of the second light source, a beat signal due to a frequency difference between the first frequency of the output signal beam and the second frequency of the reference beam;
a step of, via the second light source, performing a phase synchronization control of the frequency of the reference beam to be output from the second light source causing the frequency difference of the beat signal which is input to the control end becomes zero; and
a step of, via a multiplexer, multiplexing the phase-synchronization-controlled reference beam and the polarized beam of the first signal beam from the polarization controller.

5. (canceled)

6. The optical complex amplitude measurement method according to claim 4, wherein:
the optical complex amplitude measurement apparatus further includes a camera and a calculator, and
the method further comprises:
a step of, via the camera, capturing an interference fringe obtained by multiplexing, by the multiplexer, the reference beam after the phase synchronization control and the polarized beam of the first signal beam from the polarization controller; and
a step of, via the calculator, calculating an intensity distribution and a phase distribution of the polarized beam of the first signal beam from interference fringe information obtained by the camera.
